(19) United States
(12) Patent Application Publication
(10) Pub. No.: US 2019/0108697 A1
(43) Pub. Date: Apr. 11, 2019

(54) METHOD FOR THE CHECKING OF ACCESS AUTHORIZATIONS BY MEANS OF AN ACCESS CONTROL SYSTEM

(71) Applicant: SKIDATA AG, Grödig/Salzburg (AT)

(72) Inventors: Martin HAIDACHER, Salzburg (AT); Roland AIGNER, Hallein/Rif (AT)

(21) Appl. No.: 16/155,137

(22) Filed: Oct. 9, 2018

(30) Foreign Application Priority Data
Oct. 11, 2017 (EP) 17195991.9

(51) Int. Cl. G07C 9/00

(52) U.S. Cl. CPC G07C 9/00079; G07C 9/00103; G07C 2009/00793; G07C 9/00563; G07C 9/00119

(57) ABSTRACT

A method for checking access authorizations in which the entrance zone of the controlled area is divided into two zones that are arranged so that persons wishing to enter the controlled area pass through the first and then the second zone. The first zone is a registration zone having read/send devices. The second zone is an identification zone having cameras that record optical reference data of each person and transmit that and their current position to a server in real time. A real-time map containing the reference data is created based on the datasets. The read/send devices record IDs to which access authorizations and optical reference data are uniquely assigned. The IDs and assigned reference data are temporarily stored in an optical reference list which is compared in real time with the datasets of the real-time map.

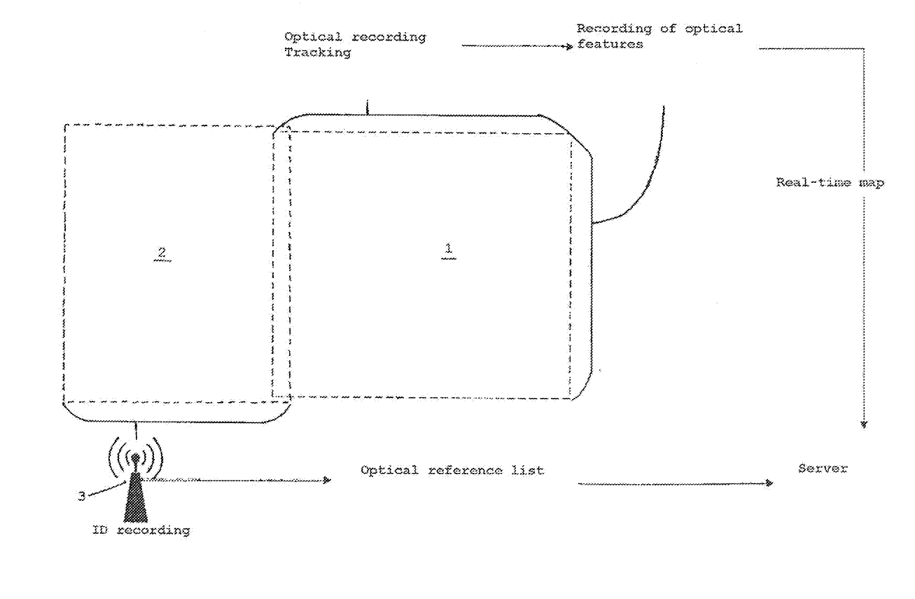

This application claims priority from European patent application serial no. 17195991.9 filed Oct. 11, 2017.

### FIELD OF THE INVENTION

The present invention relates to a method for the checking of access authorisations by means of an access control.

### BACKGROUND OF THE INVENTION

In the prior art access control devices for persons are of known art, which as a rule have means for the contactless recording and evaluation of access authorisations, together with mechanical or otherwise embodied barriers, wherein the barriers are only activated automatically or manually in the opening direction after a valid access authorisation has been presented.

Access is rendered inconvenient in a detrimental manner by the barriers and the associated blockage of access. Furthermore, the use of barriers comprising access control devices results in high manufacturing and maintenance costs.

Furthermore, access control by means of access control devices having barriers proves to be inefficient since, as a rule, the vast majority of users are in possession of a valid access authorisation. In the prior art, all users are checked in order to identify what is as a rule a very small proportion of persons with invalid or no access authorisation.

### SUMMARY OF THE INVENTION

This object underlying the present invention is that of specifying a method for the checking of access authorisations by means of an access control system, the implementation of which removes the barriers and increases convenience without compromising the quality of the checking of the access authorisations.

This object is achieved by the features of the independent claims. Accordingly, a method is proposed for the checking of access authorisations by means of an access control system, in the context of which each entrance zone of the area covered by the access control system is divided into two zones, sequential in the direction towards the entrance, so that persons wishing to enter the zone covered by the access control system must first pass through the first zone and then through the second zone. The area covered by the access control system has at least one entrance zone.

Here the first zone, which serves as a registration zone, is covered by send/read devices in accordance with at least one standard for wireless communication, wherein the second zone, which serves as an identification zone, is covered by cameras that can detect and track the persons present in this zone, wherein in the course of detection of the persons optical reference data are recorded, which are biometric features and/or features that can be uniquely assigned to the persons recorded, wherein a dataset containing the optical reference data and the current position of the person for each person detected is transmitted to the server in real time, and wherein on the basis of these datasets a real-time map containing the optical reference data is created.

In the context of further designs of the invention, the registration zone and the identification zone can partially overlap.

By means of the read/write devices that cover the registration zone, mobile electronic devices such as smart phones, tablets, or smart watches, or data storage devices such as RFID cards, record sent/read IDs, to which access authorisations and optical reference data are uniquely assigned.

In the context of an initial design of the invention, the optical reference data, for example vectors describing the biometrics of a person's face, together with the respective ID, are sent from the mobile electronic devices or the data storage devices to the read/write devices, wherein the data received by the read/write devices is transmitted to a server.

Alternatively, the optical reference data assigned to each ID can be stored on the server, to which the read/write devices transmit the recorded IDs.

In the context of a registration of persons, the optical reference data can be linked to the ID and transmitted to the server, or stored on mobile electronic devices or data storage devices.

In accordance with the invention, the IDs recorded by the read/write devices and the optical reference data associated with the IDs, which in each case are grouped into a dataset containing an ID and the optical reference data assigned to the said ID, are temporarily stored in an optical reference list on the server.

In accordance with the invention, it is envisaged that the datasets of the optical reference list are to be compared in the server with the datasets of the real-time map in real time. By this means a check is made as to whether the optical reference data of a dataset stored in the optical reference list correspond to the optical reference data of a dataset of the real-time map. If this is the case, the unique ID that is contained in the optical reference list dataset and recorded in the registration zone, is assigned to the person according to the real-time map dataset, wherein the validity of the access authorisation assigned to this ID is then checked in the server.

If the optical reference data of a real-time map dataset do not correspond to any of the optical reference list datasets with respect to the optical reference data, it is assumed that the person does not carry any access authorisation corresponding to the real-time map dataset.

In accordance with one development of the invention, in the case of a person without access authorisation, tracking of this person can be carried out by means of at least one camera, wherein a manual access check is preferably carried out on the basis of the tracking information. Furthermore, this person can be tagged by means of a laser or light beam in order to make it easier for the staff to find the person.

In accordance with a further design of the invention, in the case of a person without access authorisation, a redirection of a group of persons in which this person is located can be carried out by the activation of means for the redirection of persons, for example by the activation of turnstiles, wherein the group of persons can be redirected in such a way that the group passes through means for the checking of access authorisations comprising an access checking device with a mechanical barrier, wherein the access authorisations can be read contactlessly. The means for the redirection of persons can be activated automatically or manually by actuating a switch or a mechanical device.

### BRIEF DESCRIPTION OF THE DRAWING

The invention is explained in more detail below with the aid of the attached figure as an example.

### DETAILED DESCRIPTION OF THE PREFERRED EMBODIMENTS

In the attached figure the identification zone is identified by reference symbol 1 and the registration zone by reference symbol 2. In accordance with the invention, registration zone 2 is covered by send/read devices 3 in accordance with at least one wireless communication standard, wherein identification zone 1, is covered by cameras that can detect and track the persons present in this zone. The cameras can, for example, be embodied as 3D-cameras.

By means of the cameras, which cover the identification zone 1, optical reference data of the persons present in this zone are recorded, which are biometric features and/or features that can be uniquely assigned to the persons detected, are recorded, wherein a dataset containing the optical reference data and the current position of the person is transmitted to a server in real time for each person detected, and wherein on the basis of these datasets a real-time map containing the optical reference data is created.

In accordance with the invention, facial recognition can be executed by means of the cameras. A neural network is preferably used to generate a number vector that represents the face recorded. In accordance with one development, with a sufficiently high resolution of the cameras the retina of the persons can be scanned, and the result can be used as a biometric feature. Furthermore, a sequence of images of a person can be created and analysed, wherein a corresponding signature can be calculated on the basis of the motion sequence of the person.

If 3D-cameras are used as the cameras, the 3D-surface of a part of a person, for example the face, can be recorded, in order to calculate features that can be uniquely assigned to the person.

In accordance with one development the cameras can also be used to create images in the invisible spectrum, for example thermal images, from which features can be calculated that can be uniquely assigned to the persons detected. Furthermore, a plurality of the above methods can be combined to obtain the optical reference data.

By means of the read/write devices 3 that cover the registration zone 2, sent or read IDs, to which access authorisations and optical reference data are uniquely assigned, are recorded by way of at least one wireless communication standard, the range of which is sufficient to cover the registration zone by means of the read/write devices 3, for example by means of a WLAN-, BLE- or UWB-standard of mobile electronic devices, such as smart phones, tablets or smart watches, or data storage devices that the persons present in this zone carry with them. The use of the Bluetooth low energy standard (BLE) results in significantly lower power consumption than the conventional Bluetooth standard and a long range that can be up to 100 metres. A WLAN- or UWB-standard is also suitable for transferring the necessary information over a sufficiently long distance, comparable to that of the BLE-standard.

In the context of an initial design of the invention, together with the respective ID, also sent or read optical reference data, for example vectors that describe the biometrics of a person's face, are recorded by the read/write devices 3, which cover the registration zone 2, of mobile electronic devices, such as smart phones, tablets or smart watches, or data storage devices that the persons present in this zone carry with them, wherein the data received by the read/write devices are transmitted to the server.

Alternatively, the optical reference data assigned to each ID recorded by the read/write devices 3 can be stored on the server to which the read/write devices 3 transmit the recorded IDs.

The optical reference data, which are uniquely assigned to the sent or read IDs, are obtained by means of the methods for obtaining the optical reference data in identification zone 1. That is to say, if the optical reference data in identification zone 1 are recorded using a normal optical camera, then a normal, conventional optical camera is also used to record the optical reference data that are uniquely assigned to the sent or read IDs. This makes it possible to compare these data. In accordance with the invention, this reference data can be recorded directly at the point of sale, for example at the cash register, or at vending machines. Furthermore, these reference data can be recorded at the first access, for example at the first access to an amusement park or a ski resort. Furthermore, the reference data can be recorded by the user himself, e.g. by means of a selfie on a mobile phone. For the case in which persons attending an event have to identify themselves additionally with an ID card, for example so as to determine their age, the ID card can be scanned and reference data can thereby be obtained.

The IDs recorded by the read/write devices 3 and the optical reference data assigned to the IDs, are each grouped into a dataset containing an ID and the optical reference data assigned to this ID, and are temporarily stored in an optical reference list on the server.

In accordance with the invention, the server compares the optical reference list datasets with the real-time map datasets in real time, wherein a check is made as to whether the optical reference data of a dataset stored in the optical reference list correspond to the optical reference data of a dataset in the real-time map. If this is the case, the unique ID contained in the optical reference list dataset and recorded in registration zone 2 is assigned to the person in accordance with the real-time map dataset, wherein the validity of the access authorisation assigned to this ID, i.e. the access authorisation linked to this ID, is then checked.

If the optical reference data of a real-time map dataset do not correspond to any of the optical reference list datasets with regard to the optical reference data, it is assumed that the person does not carry an access authorisation corresponding to the real-time map dataset.

When executing the inventive method, the optical reference data of a person are compared with the optical reference data of a limited number of persons, the number depending on the size of the identification zone and the registration zone. As a rule, there will be between 10 and 50 persons, whose IDs, to whom access authorisations and optical reference data are uniquely assigned, have been recorded contactlessly in registration zone 2, and have not been assigned a unique ID in identification zone 1, which is contained in the optical reference list dataset and has been recorded in registration zone 2.

This limitation of the comparison to a small number of persons advantageously limits the probability that two persons from this number are very similar with regard to the optical reference data, so that a greater tolerance can be used as a basis for the identification of persons, i.e. when comparing the datasets of the optical reference list with the datasets of the real-time map. In this manner, the identification can have a better success rate with less complex algorithms and at a high speed.

In accordance with one design of the invention, the at least one entrance zone of the area covered by the access control system does not have any barrier devices. If a person to whom a unique ID, registered in registration zone 2 and linked to a valid access authorisation, is assigned in accordance with the inventive method, crosses a virtual line predefined on the basis of the real-time map, which corresponds to access to the area covered by the access control system, a corresponding entry is created in a server of the access control system.

If a person to whom, in accordance with the inventive method, no unique ID is assigned that is recorded in registration zone 2 and linked with a valid access authorisation, or an ID is assigned that is recorded in registration zone 2 but is not linked with any valid access authorisation, crosses the virtual line predefined on the basis of the real-time map, an unauthorised access is detected in the system, wherein an optical and/or acoustic signal is generated and a manual check can be executed. In this manner, an access control system is implemented without barriers.

In accordance with a further design, if an unauthorised access is detected, a redirection of a group of persons, comprising the person without a valid access authorisation, can be carried out by the activation of means for the redirection of persons, for example the activation of turnstiles, wherein the group of persons is redirected in such a way that means for checking the access authorisations, comprising an access control device with a mechanical barrier, are crossed, wherein the access authorisations can be read contactlessly. The means for the redirection of persons can be activated automatically or manually by actuating a switch or a mechanical device.

Alternatively, the at least one entrance zone of the area covered by the access control system has at least one access control device with in each case one barrier device, which is actuated in the opening sense if, in accordance with the real time map, a person approaches the access control device within a predefined distance, who, in accordance with the inventive method, is assigned a unique ID that is recorded in registration zone 2 and is linked to a valid access authorisation.

1. A method for the checking of access authorizations by means of an access control system, the method comprising:
dividing each entrance zone of an area covered by the access control system into first and second zones, sequential in a direction towards an entrance, so that persons wishing to enter the zone covered by the access control system must pass first through the first and then the second zone, wherein the first zone serves as a registration zone and is covered by send/read devices in accordance with at least one standard for wireless communication, wherein the second zone serves as an identification zone and is covered by cameras that can detect and track the persons present in the second zone,
during the detection of the persons, recording optical reference data, which are biometric features and/or features that can be uniquely assigned to the persons detected,
transmitting a dataset containing the optical reference data and the current position of the person for each person detected to a server in real time,
on the basis of these datasets, creating a real-time map containing the optical reference data,
recording, by means of the read/write devices, which cover the registration zone, sent or read IDs, to which access authorizations and optical reference data are uniquely assigned, by way of at least one standard for wireless communication for mobile electronic devices or data storage devices that the persons present in this zone carry with them,
grouping each of the IDs recorded by the read/write devices and the optical reference data assigned to the IDs into a dataset containing an ID and the optical reference data assigned to this ID, and are temporarily stored in an optical reference list on the server,
comparing, in the server, the datasets of the optical reference list with the datasets of the real time map in real time,
checking whether the optical reference data of a dataset stored in the optical reference list correspond to the optical reference data of a dataset of the real-time map, wherein if this is the case, the unique ID that is contained in the dataset of the optical reference list and has been recorded in registration zone, is assigned to the person in accordance with the dataset of the real-time map,
checking the validity of the access authorization assigned to this ID and wherein if the optical reference data of a dataset of the real-time map do not correspond to any dataset of the optical reference list with regard to the optical reference data, it is assumed that the person does not carry any access authorization in accordance with the dataset of the real-time map.

2. The method for the checking of access authorizations by means of an access control system in accordance with claim 1, further comprising, recording optical reference data sent or read together with the respective ID by the read/write devices of the mobile electronic devices or the data storage devices, transmitting the data received from the read/write devices to the server.

3. The method for the checking of access authorizations by means of an access control system in accordance with claim 1, further comprising, storing the optical reference data assigned in each case to an ID recorded by the read/write devices on the server to which the read/write devices transmit the recorded IDs.

4. The method for the checking of access authorizations by means of an access control system in accordance with claim 1, wherein, the at least one entrance zone of the area covered by the access control system has no barrier devices, wherein if a person who is assigned a unique ID recorded in registration zone and linked to a valid access authorization crosses a virtual line predefined on the basis of the real-time map, which corresponds to access to the zone covered by the access control system, a corresponding entry is created in a server of the access control system.

5. The method for the checking of access authorizations by means of an access control system in accordance with claim 4, wherein, if a person who is not assigned a unique ID recorded in registration zone and linked to a valid access authorization, or an ID recorded in registration zone but not linked to a valid access authorization, crosses the virtual line predefined on the basis of the real-time map, an unauthorized access is detected in the system.

6. The method for the checking of access authorizations by means of an access control system in accordance with claim 5, further comprising, if an unauthorized access is detected, generating an optical and/or acoustic signal.

7. The method for the checking of access authorizations by means of an access control system in accordance with claim 5, further comprising, if an unauthorized access is detected, redirecting a group of persons comprising the person without valid access authorization by the activation of means for the redirection of persons, wherein the group of persons is redirected in such a way that means for checking the access authorizations, comprising an access control device with a mechanical barrier, are crossed, wherein the access authorizations can be read contactlessly.

8. The method for the checking of access authorizations by means of an access control system in accordance with claim 1, wherein, the at least one entrance zone of the area covered by the access control system has at least one access control device with, in each case, one barrier device, which is actuated in the opening direction when, in accordance with the real-time map, a person approaches the access control device within a predefined distance, who is assigned a unique ID that is recorded in registration zone and is linked to a valid access authorization.
